(19) United States
(12) Patent Application Publication
(10) Pub. No.: US 2018/0262407 A1
(43) Pub. Date: Sep. 13, 2018

(54) Telemetry Architecture for Integrated Circuits and Cloud Infrastructure

(71) Applicants: Arijit Biswas, Holden, MA (US); Johan G. Van De Groenendaal, Portland, OR (US); Jeremy J. Shrall, Portland, OR (US); Jeremiah D. Williamson, Cupertino, CA (US); Rahul Khanna, Portland, OR (US); Robert F. Kwasnick, Palo Alto, CA (US); Arthur E. Handras, Hudson, NH (US); Victor T. Lau, Marlborough, MA (US)

(72) Inventors: Arijit Biswas, Holden, MA (US); Johan G. Van De Groenendaal, Portland, OR (US); Jeremy J. Shrall, Portland, OR (US); Jeremiah D. Williamson, Cupertino, CA (US); Rahul Khanna, Portland, OR (US); Robert F. Kwasnick, Palo Alto, CA (US); Arthur E. Handras, Hudson, NH (US); Victor T. Lau, Marlborough, MA (US)

(21) Appl. No.: 15/914,764

(22) Filed: Mar. 7, 2018

Related U.S. Application Data
(60) Provisional application No. 62/469,298, filed on Mar. 9, 2017.

(51) Int. Cl. H04L 12/26

(52) U.S. Cl. CPC H04L 43/04; H04L 43/12; H04L 67/12; H04L 43/065; H04L 43/062; H04L 43/0876

(57) ABSTRACT

Examples include systems and methods for implementing telemetry architecture on an integrated circuit are disclosed. In accordance with one embodiment, telemetric architecture on an integrated circuit may include a telemetric semantic space (TSS) such that the TSS is a memory space that stores a set of telemetric data from a plurality of sensors coupled to the integrated circuit. The telemetry architecture may also include a telemetry aggregator that aggregates the set of telemetric data from the plurality of sensors. Furthermore, the telemetry architecture may include a telemetry consumer that queries the telemetry aggregator for a subset of the set of telemetric data stored in the TSS.

### CROSS-REFERENCE TO RELATED APPLICATIONS

This application claims the benefit of U.S. Provisional Application Ser. No. 62/469,298 filed Mar. 9, 2017, entitled “Systems and Methods for Implementing Telemetry Architecture on an Integrated Circuit,” which application is incorporated herein by reference in its entirety.

### TECHNICAL FIELD

Embodiments described herein generally relate to integrated circuits, servers, data centers, and cloud infrastructure and to implementing telemetry architecture on an integrated circuit, server, data center, or cloud infrastructure.

### BACKGROUND

Modern microprocessors and System-on-Chip (SoC) devices typically include multiple functional-blocks, which contribute to the operation of microprocessors and/or SoCs. These different functional blocks are often referred to as intellectual property blocks or simply IPs. During operation, each of the IP blocks process events, which contribute to overall performance, power, and reliability characteristics of the system in which the microprocessor and/or SoC is implemented. Due to the complex interactions between different IP blocks, power management schemes, and quality of service guarantees; modern computing systems implemented based on microprocessors and/or SoC produce complicated environments for system software (e.g., operating systems, other applications, etc.) to comprehend and traverse. How the software stack interacts with the microprocessor and/or SoC, and particularly, the IP blocks that make up these processing components, can make a difference in the performance and efficiency of the systems implemented upon such processing components. This is particularly true for large-scale systems, such as may be implemented in server, cloud, and datacenter environments.

### BRIEF DESCRIPTION OF THE DRAWINGS

FIG. 1 illustrates an embodiment of a cloud commuting environment.

FIG. 2 illustrates an embodiment of a computer system.

FIG. 3 illustrates an embodiment of a telemetry architecture.

FIG. 4 illustrates a first embodiment of a telemetry aggregator.

FIG. 5 illustrates an embodiment of telemetry watchers.

FIG. 6 illustrates an embodiment of a common base schema.

FIG. 7 illustrates a second embodiment of a telemetry aggregator.

FIG. 8 illustrates a third embodiment of a telemetry aggregator.

FIG. 9 illustrates an embodiment of a process to secure telemetric data.

FIG. 10 illustrates a fourth embodiment of a telemetry aggregator.

FIG. 11 illustrates an embodiment of a process to hash telemetric configuration information.

FIG. 12 illustrates a fifth embodiment of a telemetry aggregator.

FIG. 13A-FIG. 13B illustrate an embodiment of a telemetry architecture implemented across virtual machines.

### DETAILED DESCRIPTION

In general, the present disclosure may be implemented to monitor key events and metrics associated with various IP blocks of a microprocessor or SoC. In some examples, such events and metrics can be monitored repeatedly, periodically, or continuously. The occurrence of events and metrics associated with these IP blocks is generally referred to as “telemetry” data and can be stored as information within the systems described herein. As used herein, telemetry is defined as information relating to one or more processes or sub-circuits on one or more integrated circuits (hosts) that is collected, sensed, measured using sensors, calculated or derived based on sensed measurement(s), and/or transmitted to other integrated circuits (consumers).

The integrated circuits referenced in this disclosure and with which telemetry data is referenced may be any suitable type of integrated circuit, such as, for example, microprocessors, application-specific integrated circuits (ASICs), digital signal processors (DSPs), memory circuits, or other integrated circuits. If desired, the integrated circuits may be programmable integrated circuits that contain programmable logic circuitry, such as, for example, field-programmable gate-arrays (FPGAs). In the following description, the terms ‘circuitry’ and ‘circuit’ are used interchangeably. These integrated circuits can be implemented can include any of a variety of different functional blocks, of IPs. These functional blocks can include processor cores (e.g., cores capable of decoding and executing various instruction sets, or the like), accelerators (e.g., FPGAs, compression engines, graphics processing units, or the like), interconnect fabric, or Input/Output (I/O) controllers (e.g., a memory controller, a Peripheral Component Interconnect Express (PCIe) controller, a Universal Serial Bus (USB) controller, or the like).

These integrated circuits, and for example, the hosts and consumers referenced above, may be a part of a variety of devices or systems. For example, such integrated circuits can be implemented in data centers, personal computers (PCs), smartphones, cars, or other such devices and systems that may include integrated circuits. The information can be used to monitor, control, or modify the hosts. For example, events, occurrences, or changes related to physical and logical phenomena of a sub-circuit (e.g., temperature, current voltage, bandwidth, droop, errors, and time in state, or the like) can be used to generate telemetric data, which in turn can be used to alter the state of the sub-circuit.

Techniques for implementing telemetry architecture on an integrated circuit are discussed. In accordance with one embodiment, telemetric architecture on an integrated circuit may include a telemetric semantic space (TSS) such that the TSS is a memory space that stores a set of telemetric data from a plurality of sensors coupled to the integrated circuit. The telemetry architecture may also include a telemetry aggregator that aggregates the set of telemetric data from the plurality of sensors. Furthermore, the telemetry architecture may include a telemetry consumer that queries the telemetry aggregator for a subset of the set of telemetric data stored in the TSS. In the following description, the terms ‘telemetric data,’ ‘telemetry information,’ and ‘telemetry’ are used interchangeably.

This telemetric data can be utilized for a variety of observations and subsequent modifications to the observed circuits. Some specific use cases include monitoring physical conditions of sub-circuits (for example temperature, current, and voltage) as they change, power management related debugging and analysis, feedback loops for reliability, power, and performance management, implementing autonomics solutions, and continuous real-time filed monitoring via software and firmware agents.

A telemetry architecture may also be used to collect telemetric data in a cloud data center environment. For example, telemetric data may be used to implement quality of service (QoS) schemes in data center interconnect (DCI) solutions, software defined networking (SDN), or network function virtualizations (NFV) solutions.

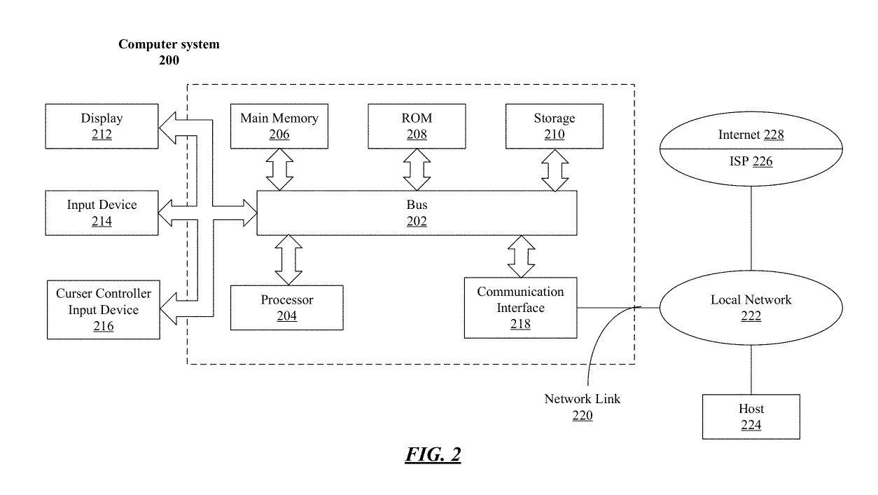

Telemetric data may also be used to perform on-line and off-line analysis for performance management and increasing efficiency for various circuits and systems. For example, analysis of thermal telemetric data from a storage device like storage device 210 described above in relation with FIG. 2 may help improve device performance under peak conditions.

Techniques for implementing telemetry architecture on an integrated circuit are discussed. In accordance with one embodiment, telemetric architecture on an integrated circuit may include a telemetric semantic space (TSS) such that the TSS is a memory space that stores a set of telemetric data from a plurality of sensors coupled to the integrated circuit. The telemetry architecture may also include a telemetry aggregator that aggregates the set of telemetric data from the plurality of sensors. Furthermore, the telemetry architecture may include a telemetry consumer that queries the telemetry aggregator for a subset of the set of telemetric data stored in the TSS. In the following description, the terms ‘telemetric data,’ ‘telemetry information,’ and ‘telemetry’ are used interchangeably.

The telemetric data stored in the TSS may be utilized for a variety of observations and subsequent modifications to the observed circuits. Some specific use cases include: monitoring physical conditions of sub-circuits (for example temperature, current, and voltage) as they change, power management related debugging and analysis, feedback loops for reliability, power, and performance management, implementing autonomics solutions, or continuous real-time filed monitoring via software and firmware agents.

The described telemetry architectures may be used to collect telemetric data in a cloud data center environment. Such telemetric data may be used to implement quality of service (QoS) schemes in data center interconnect (DCI) solutions, software defined networking (SDN), or network function virtualizations (NFV) solutions. The telemetric data may also be used to perform on-line and off-line analysis for performance management to increase efficiency for various circuits and systems. For example, analysis of thermal telemetric data from a storage device or array of storage devices may be used to modify operation of the storage device or array to improve device performance under peak conditions.

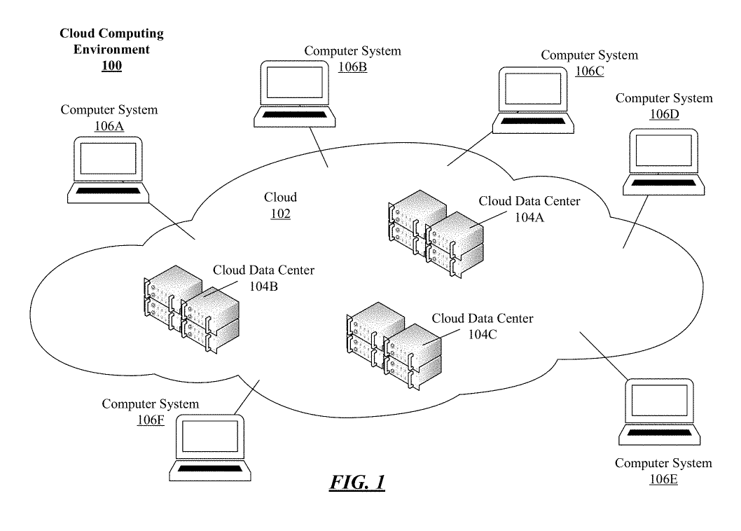

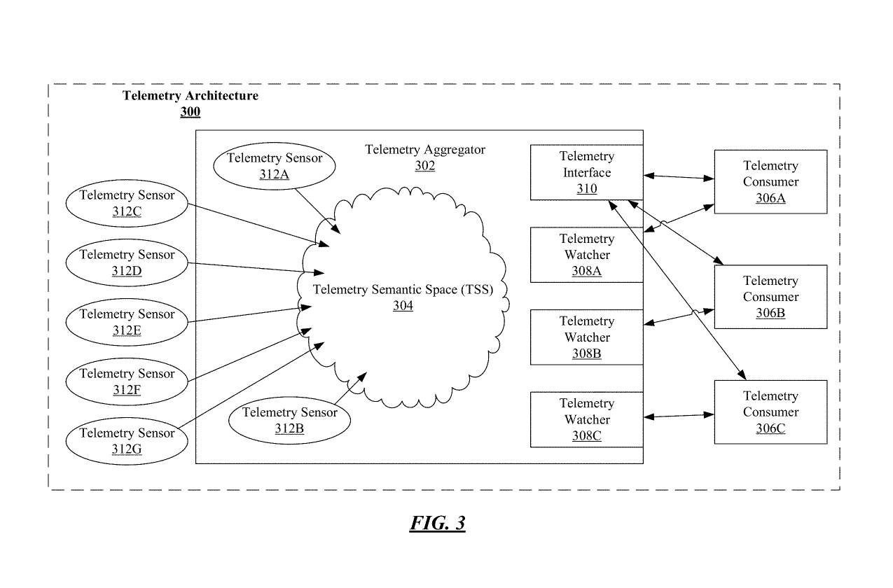

An exemplary telemetry architecture is depicted as described with reference to FIG. 3. However, as the telemetry architecture and methods associated with collecting telemetry data and altering the state of a system in response to the telemetric data can be implemented in a variety of computing systems; an example cloud computing environment and computing system are given with respect to FIG. 1-FIG. 2. Specifically, FIG. 1 depicts an example cloud computing environment 100 including multiple computer systems, each of which include integrated circuits and can implement the telemetry architecture discussed herein. FIG. 2 depicts a computer system 200, which could be implemented as one of the computer systems or computing devices of the environment 100 of FIG. 1.

### Cloud Computing Environment and Computer System

FIG. 1 illustrates exemplary cloud computing environment 100, in accordance with embodiments of the present disclosure. It is to be appreciated, cloud computing is a model of service delivery for enabling on-demand network access to a shared pool of configurable computing resources (e.g. networks, network bandwidth, servers, processing resources, memory resources, storage resources, applications specific resources, virtual machines, services, or the like). In typical cloud computing systems, one or more data centers house the physical computing resources (e.g., computing devices, or the like) used to deliver the services provided by the “cloud.” As depicted, the exemplary cloud computing environment 100 includes cloud data centers 104A, 104B, and 104C, which are interconnected through cloud 102. Data centers 104A, 104B, and 104C provide cloud computing services to computer systems 106A, 106B, 106C, 106D, 106E, and 106F connected to cloud 102.

In general, cloud data centers (e.g., cloud data centers 106A-106B) refer to the physical computing resources (e.g., servers, or the like) that make up cloud 102, or a portion of cloud 102. In some examples, these servers can be physically arranged in the cloud datacenter into rooms, groups, rows, and racks. A cloud datacenter may have multiple zones, which may include different rooms of servers. Each room may have a number of rows of servers, with each row including multiple racks and each rack including a number of individual server nodes. Servers in zones, rooms, racks, and/or rows may be arranged into groups based on physical infrastructure requirements of the datacenter facility and/or based on the type of physical resource (e.g., computing resource, storage resources, or the like). In some examples, power, energy, thermal, heat, and/or other requirements can be used to group the actual nodes of servers in the cloud data centers.

Cloud data centers 104A, 104B, and 104C further include network and networking resources (e.g., networking equipment, nodes, routers, switches, networking cables, or the like) that interconnect cloud data centers 104A, 104B, and 104C and help facilitate access of cloud 102 (or access to services provided by cloud 102) by computing systems 106A to 106F. The cloud computing environment 100 can include and be interconnected using any combination of local networks, wide area networks, or internetworks provided using wired and/or wireless links. These wired and/or wireless links can be deployed using terrestrial or satellite connections. Data exchanged over the network(s) may be transferred using any number of network layer protocols. For example, cloud computing environment 100 can exchange data using the Internet Protocol (IP), Multiprotocol Label Switching (MPLS), Asynchronous Transfer Mode (ATM), Frame Relay, or the like. In embodiments where the network is implemented using a combination of multiple sub-networks, different network layer protocols may be used at the underlying sub-networks. Additionally, with some examples, the network may represent one or more interconnected internetworks, such as the public Internet.

Computing systems 106A to 106F coupled to cloud 102 may be computing devices arranged to consume cloud services, or to consume services provided by cloud 102. Computing systems 106A-106F may be connected to cloud 102 through network links and network adapters, which may be wired and/or wireless. The computing systems 106A-106F may be implemented as various computing devices, for example servers, desktops, laptops, tablet, smartphones, “smart” devices (e.g., Internet-of-Things (IoT) devices, networked media devices, network enabled automation devices, or the like). Computing systems 106A-106F may also be implemented in or as a part of other systems for example consumer electronics and automobiles, among other systems or devices.

In general, nodes of cloud data centers 104A-104C and/or computing devices 106A-106F may be implemented using any of a variety of computing devices, including integrated circuits. FIG. 2 depicts an example computer system 200, which may be representative of portions of the cloud data center 104A-104C and/or computing devices 106A-106F. Turning now to FIG. 2, computer system 200 is depicted. Computer system 200 may be implemented in accordance with embodiments of the present disclosure. In some examples, computer system 200 is a special-purpose computing device. The special-purpose computing devices may be hard-wired (e.g., include specially designed circuits) to perform techniques. For example, such special-purpose computing devices may include digital electronic devices such as ASICs or FPGAs that are persistently programmed to perform the techniques, general purpose hardware processors programmed to perform the techniques pursuant to program instructions in firmware, memory, other storage, or a combination or such devices. Such special-purpose computing devices may also combine custom hard-wired logic (e.g., ASICs, FPGAs, or the like) with custom programming to accomplish the techniques. The special-purpose computing devices may be desktop computer systems, portable computer systems, handheld devices, network devices or any other device that incorporates hard-wired and/or program logic to implement the techniques.

As depicted, computer system 200 may include a bus 202 (or other communication interface) for communicating information and a hardware processor 204 coupled with bus 202 for processing information. Hardware processor 204 may be, for example, a general-purpose microprocessor. In some examples, hardware processor 204 may comprise a number of virtual processor(s) or may comprise of portion (e.g., core(s), or the like) of a hardware processor.

Computer system 200 also includes a main memory 206, such as a random-access memory (RAM) or other dynamic storage device, coupled to bus 202 for storing information and instructions to be executed by processor 204. Main memory 206 also may be used for storing temporary variables or other intermediate information during execution of instructions to be executed by processor 204. Such instructions, when stored in non-transitory storage media accessible to processor 204, render computer system 200 into a special-purpose machine that is customized to perform the operations specified in the instructions.

Computer system 200 further includes a read only memory (ROM) 208 or other static storage device coupled to bus 202 for storing static information and instructions for processor 204. A storage device 210, such as a magnetic disk, optical disk, or solid-state drive is provided and coupled to bus 202 for storing information and instructions.

Computer system 200 may be coupled via bus 202 to a display 212 for displaying information (e.g., to a user of computer system 200, or the like). Display 212 can be based on any of a variety of display technologies, such as, for example, a cathode ray tube (CRT), a liquid crystal display (LCD), plasma display, light emitting diode (LED) display, or an organic light emitting diode (OLED) display. Computer system 200 may additionally include an input device 214 (e.g., including alphanumeric and/or other keys) coupled to bus 202 for communicating information and command selections to processor 204. Computer system 200 may additionally include a cursor-controller input device 216, such as a mouse, a trackball, a touch-enabled display, or cursor direction keys for communicating direction information and command selections to processor 204 and for controlling cursor movement on display 212. With some examples, cursor-controlled input device 216 can have degrees of freedom in multiple axes, a first axis (e.g., x) and a second axis (e.g., y), that allows the device to specify positions in a plane.

In some embodiments, the techniques discussed herein can be performed by computer system 200, for example, in response to processor 204 executing one or more sequences of one or more instructions contained in main memory 206. Such instructions may be read into main memory 206 from another storage medium, such as storage device 210. Execution of the sequences of instructions contained in main memory 206 causes processor 204 to perform the process steps described herein. In alternative embodiments, hard-wired circuitry may be used in place of or in combination with such “software instructions.”

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 210. Volatile media includes dynamic memory, such as main memory 206. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge.

It is to be appreciated that storage media is distinct from, but may be used in conjunction with, transmission media. Transmission media participates in transferring information between storage media. For example, transmission media includes coaxial cables, copper wire and fiber optics, including the wires that comprise bus 202. Transmission media can also take the form of acoustic or light waves, such as those generated during radio-wave and infra-red data communications. Various forms of media may be involved in carrying one or more sequences of one or more instructions to processor 204 for execution. For example, the instructions may initially be carried on a magnetic disk or solid-state drive of a remote computer. The remote computer can load the instructions into its dynamic memory and send the instructions over a telephone line using a modem. A modem local to computer system 200 can receive the data on the telephone line and use an infra-red transmitter to convert the data to an infra-red signal. An infra-red detector can receive the data carried in the infra-red signal and appropriate circuitry can place the data on bus 202. Bus 202 carries the data to main memory 206, from which processor 204 retrieves and executes the instructions. The instructions received by main memory 206 may optionally be stored on storage device 210 either before or after execution by processor 204.

Computer system 200 can also include a communication interface 218 coupled to bus 202. Communication interface 218 provides a two-way data communication coupling to a network link 220 that is connected to a local network 222. For example, communication interface 218 may be an integrated service digital network (ISDN) card, cable modem, satellite modem, or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic or optical signals that carry digital data streams representing various types of information.

Network link 220 typically provides data communication through one or more networks to other data devices. For example, network link 220 may provide a connection through local network 222 to a host computer 224 or to data equipment operated by an Internet Service Provider (ISP) 226. ISP 226 in turn provides data communication services through the world-wide packet data communication network now commonly referred to as the “Internet” 228. Local network 222 and Internet 228 both use electrical, electromagnetic or optical signals that carry digital data streams. The signals through the various networks and the signals on network link 220 and through communication interface 218, which carry the digital data to and from computer system 200, are example forms of transmission media. In an embodiment, network link 220 may contain or may be a part of cloud 102 described above.

Computer system 200 can send messages and receive data, including program code, through the network(s), network link 220 and communication interface 218. In an embodiment, computer system 200 may receive code for processing. The received code may be executed by processor 204 as it is received, and/or stored in storage device 210, or other non-volatile storage for later execution.

### Telemetry Architecture

Turning now to FIG. 3, telemetry architecture 300 is depicted. Telemetry architecture 300 can be implemented on an integrated circuit, for example, in accordance with embodiments of the present disclosure. In some examples, telemetry architecture 300 may be implemented on an integrated circuit included in a cloud data center (e.g., cloud data center 104A, cloud data center 104B, cloud data center 104C, or the like) described above. Likewise, telemetry architecture 300 could also be implemented on a computer system (e.g., one of computer systems 106A to 106F, computer system 200, or the like).

As depicted, telemetric architecture 300 includes telemetric aggregator 302, telemetric semantic space (TSS) 304, telemetry consumer 306A, telemetry consumer 306B, telemetry consumer 306C, telemetry watcher 308A, telemetry watcher 308B, telemetry watcher 308C, telemetry Interface 310, and telemetry sensors 312A, 312B, 312C, 312D, 312E, 312F, and 312G.

In general, TSS 304 describes a set of telemetry information, which can be generated and/or exposed by telemetry aggregator 302, for example, from control signals, information elements, or other signals obtained from ones of telemetry sensors 312A to 312G. In some examples, the type and form of events and metrics that generate telemetric data and are available in TSS 304 may be dependent on the underlying integrated circuit. The events and metrics may be provided with the underlying integrated circuit in an externally consumable software format for in-band telemetry consumers. For example, such format may be implemented via Extensible Markup Language (XML) or JavaScript Object Notation (JSON). Further, the format may provide information on how to map values from metrics to enumeration as well as how to convert the values from events and metrics into a meaningful representation of the telemetric data. Some examples of different types of values and their descriptions are given in Table 1 referenced below.

TABLE 1
Example Value Types and Descriptions.

| Type of Value | Description |
|---|---|
| Continuous | Telemetric data is continuous in nature (e.g., |
| | voltage, temperature, or the like). |
| Status | Telemetric data is discontinuous and |
| | composed of distinct elements, which may |
| | have non-ordinal relationship(s) to each other. |
| Residency | Telemetric data represents a counter with |
| | units of time. |
| Counter | Telemetric data represents a counter, which |
| | may have unknown units. |
| Delta Counter | Telemetric data represents a counter, which |
| | may have unknown units and a delta from a |
| | previous value. |
| Event | Telemetric data represents an occurrence of |
| | an event. The telemetric data value may |
| | cause the event to be matched. |
| Enumerated Event | Telemetric data represents an occurrence of |
| | an event and may be used to qualify the event. |
| Latency | Telemetric data represents or is used to |
| | compute the latency of one event with respect |
| | to another event. |
| Histogram | Telemetric data represents a histogram. |

Depending upon the embodiment, TSS 304 can be implemented as a single memory space or a distributed memory space (e.g., with a contiguous address space, or the like). In some examples, TSS 304 may be implemented as a Static RAM exposed to a memory-mapped input-output space. In some examples, there is a 1:1 (one-to-one) mapping between telemetry aggregator 302 and TSS 304. In some examples, TSS 304 is a flat memory space, which includes all telemetric sensors that telemetry aggregator 302 may use to collect telemetric data. In such an example, the format of the flat space may be defined in the XML Definition for telemetry aggregator 302. In some examples, composition of TSS 304 is determined by explicit construction.

With some examples, telemetry sensors 312A to 312G are intellectual property (IP) blocks of the integrated circuit (or SoCs) in which architecture 300 is implemented. These IP blocks are communicatively coupled to desired sub-circuits to collect telemetric data. In general, telemetry sensors 312A to 312G are arranged to measure certain physical and/or logical phenomena associated with the sub-circuit being monitored. For example, telemetry sensor 312A could be arranged to monitor temperature (using distributed temperature sensing systems), current voltage (using fully integrated voltage rails), bandwidth (using free running counters), concurrency (using counters), droop (using voltage droop method systems), energy (using energy counters), current (using CPU load current monitor), wear out or aging, (using reliability odometers), electrical margins (using double data rate training), errors (using machine check architecture banks), and time in state (using time-in-state residency), or the like. It is to be appreciated, that each of telemetry sensors 312B to 312G may be arranged to monitor different physical and/or logical phenomena than that which telemetry sensor 312A is arranged.

Telemetry sensors 312A to 312G are further configured to share or report the collected telemetric data to telemetric aggregator 302. Telemetric aggregator 302 is arranged to store the reported data in TSS 304. With some examples, ones of telemetric sensors 312A to 313G reports or shares the telemetric data through wireless communication protocol (e.g., Wi-Fi, Bluetooth, Bluetooth Low energy, Near Field Communication (NFC), ZigBee, or the like). In some examples, ones of telemetric sensors 312A to 313G may report or share data through a shared data bus, wired communication, or other well-known data communication technology.

With some examples, telemetry interface 310 provides telemetry consumers 306A to 306C access to telemetry aggregator 302 to retrieve telemetric data stored in TSS 304. For example, Access of telemetry interface 310 by a telemetry consumer (e.g., ones of 306A to 306C) may require telemetry-specific commands to be sent and decoded on a communication bus of the integrated circuit. The communication bus may be similar to bus 202 of computer system 200 described above. The telemetry consumer (e.g., 306A to 306C) may be an in-band telemetry consumer or an out-of-band telemetry consumer. Examples are not limited in this context.

Telemetry commands may be mapped onto the existing protocol of the communication bus. As used herein, “telemetry commands” are commands issued by software, firmware, or other sources to discover, access, and configure telemetry data. Examples of telemetry commands may include commands to initiate discovery of the types of telemetry supported by a telemetry aggregator 302, write data to configuration registers of a telemetry watcher 308A to 308C, read the state of a configuration register of a telemetry watcher 308A to 308C, and read the telemetric data stored in TSS 304. Telemetry commands can be specified in the XML or JSON description of the TSS.

With some examples, additional messages or new messages can be added or extended onto existing message encodings to encompass telemetry specific commands and requests (e.g., discovery, access, configuration as well providing the ability to specifically identify and differentiate telemetry traffic from other types of activity on the communication bus). It could also include an ability to enforce traffic quality of service (QoS) protocols such that higher priority traffic is not adversely affected due to the shared nature of the communication bus.

In some examples, telemetry interface 310 can be mapped onto a bus (e.g., a Management Component Transport Protocol (MCTP) bus). It is to be appreciated, that an MCTP bus may provide for the differentiation between local traffic and telemetry related traffic and may apply traffic QoS to ensure that the telemetry traffic on the MCTP bus does not impact local traffic. With some examples, the MCTP headers can be modified to map telemetry interface 310 to the MCTP bus.

In further examples, telemetry interface 310 can stream telemetric data to out-of-band telemetry consumers (e.g., telemetry consumers 306A to 306C). For example, telemetry interface 310 may be arranged to send an MCTP payload to an endpoint that is designed to receive MCTP packets. The MCTP packets can include both the IP address of the destination and the port information.

### Telemetry Aggregator

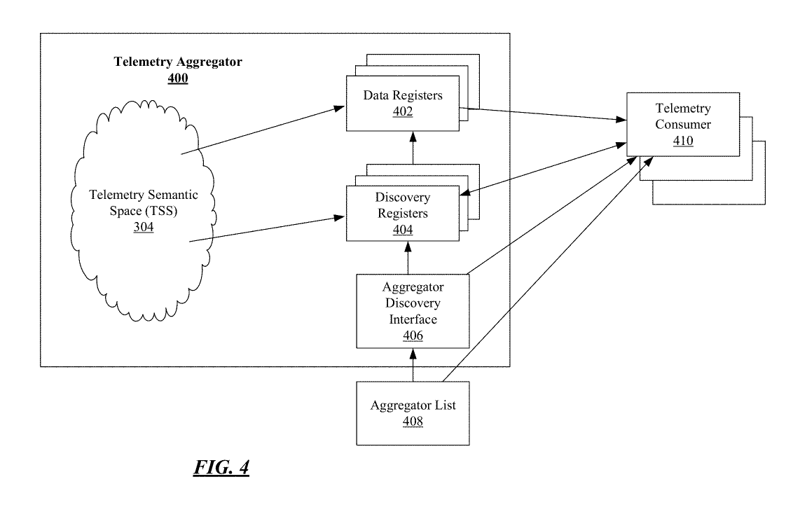

FIG. 4 depicts an exemplary telemetry aggregator 400, implemented on an integrated circuit in accordance with embodiments of the present disclosure. The telemetry aggregator 400 can be representative of the telemetry aggregator 302 of telemetry architecture 300 FIG. 3. As such, for purposes of clarity, FIG. 4 and the telemetry aggregator 400 are discussed in relation to telemetry architecture 300 of FIG. 3. As depicted, telemetry aggregator 400 includes data registers 402, discovery registers 404, and aggregator discovery interface 406. Telemetry aggregator 400 may be accessible by telemetry consumers 410 through an aggregator list 408. In some examples, telemetry aggregator 400 may be a firmware agent arranged to collect or produce telemetric data for a sub-circuit on an integrated circuit and make it available to telemetry consumers 410. As noted above, some embodiments provide a one-to-one (1:1) matching between a telemetry aggregator and a TSS. Thus, as depicted, telemetry aggregator 400 is associated with one TSS, for example TSS 304. In some examples, telemetry aggregator 400 can be implemented in the integrated circuit using a combination of static memory (e.g., RAM) and firmware. With some examples, telemetry aggregator 400 is implemented in the integrated circuit using dedicated hardware (e.g., ASICs, FPGAs, etc.). In some examples, telemetry aggregator 400 is implemented in the integrated circuit using a combination of dedicated hardware circuits and software.

In general, aggregator list 408 is a list of all telemetric aggregators available to each of telemetry consumers 410. Aggregator list 408 may be stored on a storage device (e.g., main memory 206, ROM 208, storage device 210, or the like of computer system 200) associated with the telemetry architecture (e.g., telemetry architecture 300). The storage device on which aggregator list 408 is stored may be located on the same integrated circuit as an internal storage device, may be connected to the integrated circuit as an external storage device, or may be a remote storage device. Each telemetric aggregator 400 listed in aggregator list 408 can link to aggregator discovery interface 406. In some example, there may be more than one telemetry aggregator 400 in a system or device. For example, even if there is only one telemetry aggregator 400 within an SoC, there may be more than one telemetric aggregator 400 within a platform or device. For example, a server rack in a cloud data center may include multiple SoCs, each with a number of processing elements (e.g., central processing units (CPUs), or the like). As such, each SoC may have a separate telemetry aggregator 400 and the server rack will have multiple telemetry aggregators 400.

Aggregator discovery interface 406 provides telemetry consumers 410 to determine the different sub-circuits and telemetric data for the sub-circuits that is available for collection, monitoring, or modifying to the consumer 410. In some examples, aggregator discovery interface 406 is accessible from both host-based (in-band) and out-of-band telemetry consumers 410.

Discovery registers 404 are communicatively coupled to TSS 304 and telemetry consumers 410. In general, discovery registers 404 store information relating to capabilities of telemetry aggregator 400 received from TSS 304. Discovery registers 404 may also provide stored information to telemetry consumers 410. Said differently, discovery registers 404 can allow telemetry consumers 410 access to telemetry aggregator 400 and the associated TSS 304. The information stored in discovery registers 404 may include control and configuration instructions for telemetry aggregator 302.

Data registers 402 are coupled to the telemetry consumers 410 and TSS 304. Data registers 402 are arranged to provide telemetric consumers 410 access to telemetric data generated by telemetric sensors (e.g., telemetric sensors 312A to 312G) and stored in TSS 304. With some examples, data registers 402 are implemented within telemetry aggregator 400. Data registers 402 can utilize message queues and/or mailboxes for passing control of telemetry aggregator 400 to telemetry consumers 410 or to allow access to telemetric data stored in TSS 304 by telemetric consumers 410. Data registers 402 that are implemented within telemetry aggregator 400 may store power characteristics of telemetry aggregator 400. For example, whether telemetry aggregator 400 is powered up or powered down. In some examples, data registers 402 may store the availability characteristics of telemetry aggregator 400. For example, whether telemetry aggregator 400 is available or busy. In some examples, data registers 402 require handling by telemetry aggregator 400, such as, through specified hardware or firmware whenever telemetry consumers 410 choose to access telemetric data from telemetric aggregator 400.

In some examples, data registers 402 may be implemented in a common block of shared interconnect resources. In such an example, telemetric data may be pushed to data registers 402 in the common block. The telemetric data may be pulled by telemetry consumers 410 once telemetry consumers 410 are notified that the telemetric data is available. With some examples, the common block may be shared between multiple telemetry aggregators 400 and associated groups of telemetry consumers. With some examples, the common block (and thus the data registers 402) may be available regardless of the power state of the telemetry aggregators and associated groups of telemetry consumers sharing the block.

With some examples, data registers 402 may be implemented in telemetry consumers 410 to provide low latency access to telemetric data pushed by telemetry aggregator 400 to telemetry consumers 410. Telemetry aggregator 400 can query the power state of a telemetry consumer 410 before pushing telemetric data to the telemetry consumer 410. With some examples, a telemetry consumer can be updated when telemetry aggregator 400 pushes telemetric data to the telemetric consumer 410, even when the telemetric consumer 410 is powered down. In some examples, data registers 402 may be implemented in either telemetry aggregator 400, a shared block, or telemetry consumers 410. In some examples, data registers 402 can be implemented in a combination of telemetry aggregators 400, a shared block, and telemetry consumers. That is, some telemetry aggregators 400 and some telemetry consumers 410 in a system may implement data registers 402 while other data registers 402 in the system may be implemented in a shared block.

As noted, telemetry consumers 410 can be any of a variety of computing devices, such as, a PC. During operation, such a PC (acting as a telemetry consumer 410) may wish to collect telemetric data from a temperature sensor monitoring the temperature of a sub-circuit of an integrated circuit in a server in a cloud data center. The sub-circuit may be connected to other components of the integrated circuit via a bus (e.g., a PCI bus, or the like). To access the telemetry architecture resources associated with the telemetry aggregator coupled to the sensors monitoring the sub-circuit, the PC will acquire a link to the appropriate aggregator interface 4065 from an aggregator list 408. The aggregator interface 4065 can enable the PC to communicate with the discovery registers 404 that store the appropriate information pertaining to the PCI configuration space that will allow the PC to access and control the telemetry aggregator 400. The telemetry aggregator 400 can then receive access requests from the PC and push the temperature related telemetric data to the PC via the data registers 402.

### Telemetry Watchers

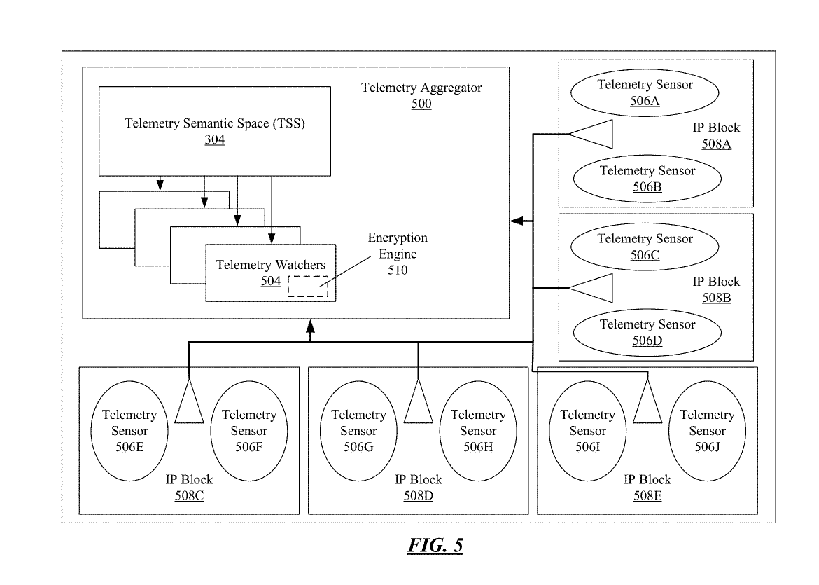

FIG. 5 depicts exemplary telemetry watchers 504 of a telemetry aggregator 500, implemented on an integrated circuit in accordance with embodiments of the present disclosure. The telemetry watchers 504 can be representative of the telemetry watchers 308A to 308C of telemetry architecture 300 FIG. 3. As such, for purposes of clarity, FIG. 5 and the telemetry watchers 504 are discussed in relation to telemetry architecture 300 of FIG. 3. As discussed herein, telemetry aggregator 500 is mapped to TSS 304. TSS 304 can support telemetry watchers 504. Telemetry watchers 504 are interfaced with telemetry sensors 506A, 506B, 506C, 506D, 506E, 506F, 506G, 506H, 506I, and 506J. Telemetry sensors 506A to 506J can be implemented on IP blocks within an integrated circuit associated with telemetry aggregator 500. For example, telemetry sensors 506A and 506B are depicted implemented on IP block 508A, telemetry sensors 506C and 506D are depicted implemented on IP block 508B, telemetry sensors 506E and 506F are depicted implemented on IP block 508C, telemetry sensors 506G and 506H are depicted implemented on IP block 508D, and telemetry sensors 506I and 506J are depicted implemented on IP block 508E. It is noted, an IP block can include any number of telemetry sensors (e.g., zero, one, two, three, or the like) and the examples depicted here are not intended to be limiting.

Telemetry sensors 506A to 506J can be implemented and arranged to generate telemetric data relating to specific attributes (e.g., temperature, voltage, or the like) of the respective IP block 508A to 508E upon which the telemetry sensor 506A to 506J is implemented. Telemetry consumers (refer to FIG. 3-FIG. 4) use telemetry watchers 504 to request telemetric data relating to specific metrics and/or events from telemetry aggregator 500. Telemetry watchers 504 determine the frequency of generating telemetric data from telemetry sensor(s) of a particular IP block. Telemetry watchers 504 may also determine the thresholds for physical and/or logical attributes that generate telemetric data. For example, a telemetry watcher 504 may be programmed or set up to observe temperature conditions for a sub-circuit and generate telemetric data (e.g., time-stamped measurements of temperature, or the like) only if observed temperature rises above a threshold (e.g., thirty degrees Celsius, or the like).

Telemetry watchers 504 may also determine if a telemetry sensor should generate alerts regarding telemetric data being generated. For example, telemetry sensors 506A and/or telemetry sensor 506B can determine the state of telemetry sensors 506A or 506B and the state of IP block 508A and generate an alert accordingly. As such, telemetry sensor 506A and 506B can be arranged to eliminate the need for specialized software or hardware to continually poll IP block 508A for telemetry data, thereby increasing efficiency and reducing consumed bandwidth.

With some examples, telemetry watchers 504 are defined according to the definitions set forth in telemetry architecture 300. For example, a telemetry watcher may be implemented to include an interrupt configuration registers, a global time stamp, and an interrupt watcher register. The number of instances of telemetry watchers 504 may be determined according to the definition specified in telemetry architecture 300. In some examples, a telemetry watcher 504 may be instantiated by defining IP block to be observed (e.g., IP block 508A, IP block 508B, etc.) and the type of telemetric data to be recorded via telemetry sensors of the defined IP block (e.g., telemetry sensors 506A and 506B, telemetry sensors 506C and 506D, etc.). The instantiated telemetry watcher 504 can further to defined to specify the frequency of capturing the telemetric data generated by telemetric sensors and stored in TSS 304 by telemetry aggregator 302. The instantiated telemetry watcher 504 can further be defined to specify an action to take against a known threshold value of the telemetric data. For example, a telemetric watcher 504 may be instantiated to interrupt the functioning of IP block 508A in case the values of telemetric data being stored in TSS 304 cross a pre-determined threshold value.

Telemetry watchers 504 can be programmed to perform statistical analysis (e.g., averaging the telemetric data, generating standard deviations, determining the minimum/maximum values, or the like) for the telemetric data stored in TSS 304. In some examples, there is a 1:1 mapping between a telemetry consumer and a telemetry watcher. With other examples, there may be a many to one-to-many (1:N) mapping of a telemetry watchers 504 to TSS 304. In some examples, each of telemetry watchers 504 may be made available in a catalog of telemetry watchers 504, with which integrated circuit manufacturers or device manufacturers may choose from in terms of implementation according to requirements of customers and the market. The catalog of telemetry watchers 504 may be made available in the definitions included in telemetry architecture 300.

Telemetry watchers 504 used by in-band telemetry consumers can share the same form and functionality as telemetry watchers 504 used by out-of-band telemetry consumers. However, depending upon the definitions specified in telemetry architecture 300, the architecture of the integrated circuit on which IP blocks are located, and the nature of the telemetry consumer consuming the telemetric data being generated, a telemetry watcher 504 may be exposed to an out-of-band consumer via different methods.

With some examples, telemetric data may be collected in “raw form” using telemetry watchers 504. Said differently, telemetric data may be collected from telemetry watchers 504 in native format as output by the telemetry sensors (e.g., telemetry sensors 506A to 506J). With some examples, telemetry watchers 504 may encrypt telemetry data and/or may create unique events that are intended to obfuscate the telemetry data. Ones of the telemetry watchers 504 may include a “stealth mode” option in which the telemetry watchers 504 can protect certain available events and/or telemetry data. Such telemetry watchers (e.g., arranged to provide a stealth mode) may include an encryption engine 510. As such, telemetry data associated with telemetry aggregator 302 can be protected. For example, integrated circuits may include classified or protected IP blocks (e.g., as may be used by governments or other institutions). As another example, cloud data centers for servicing IoT data, SDI based solutions, and programmable logic-based IP resources often need to exchange telemetric data that is encrypted to protect the telemetry resources.

During operation of telemetry watchers in stealth mode, the basic telemetry framework and architecture may remain unchanged. However, the private sensor data may be encrypted (e.g., by encryption engine 510, by telemetry sensor source, or the like) and the TSS configuration can identify which sensor data is protected. The SDI orchestration layer may catalog the unique configuration with a unique Tss version ID. Stealth mode enabled telemetry watchers 504 provide seamless participation of future products and updates (which are deemed privacy sensitive) in the telemetry architecture 300 without losing data privacy. An exemplary architecture for a part of a stealth telemetry watcher is described in Table 3 below.

TABLE 3
Stealth Mode Telemetry Watcher Architecture

| Field | Size | Value |
|---|---|---|
| cmplCode | 8 | Compilation code values |
| | | 0 × 40 = Success |
| | | 0 × 80 = Fail |
| EntryType | 8 | Indicates the entry type and |
| | | identifies if the source |
| | | data is protected. |
| TelemType | 8 | Identifier to describe the |
| | | telemetry endpoint. May also |
| | | define if the endpoint is |
| | | encrypted or private. |
| | | Encrypted type does |
| | | not participate in |
| | | telemetry watchers as |
| | | the data is scrambled. |
| | | Private type does not |
| | | participate in TSS xml |
| | | reporting, but can |
| | | participate with |
| | | telemetry watchers. |
| Unique ID | 16 | Used in conjunction with |
| | | PlatformID to pull the |
| | | associated XML Definition |
| TelemSpace Size | 16 | Indicates the size of the |
| | | telemetry memory space |
| | | in double words (32 bits). |

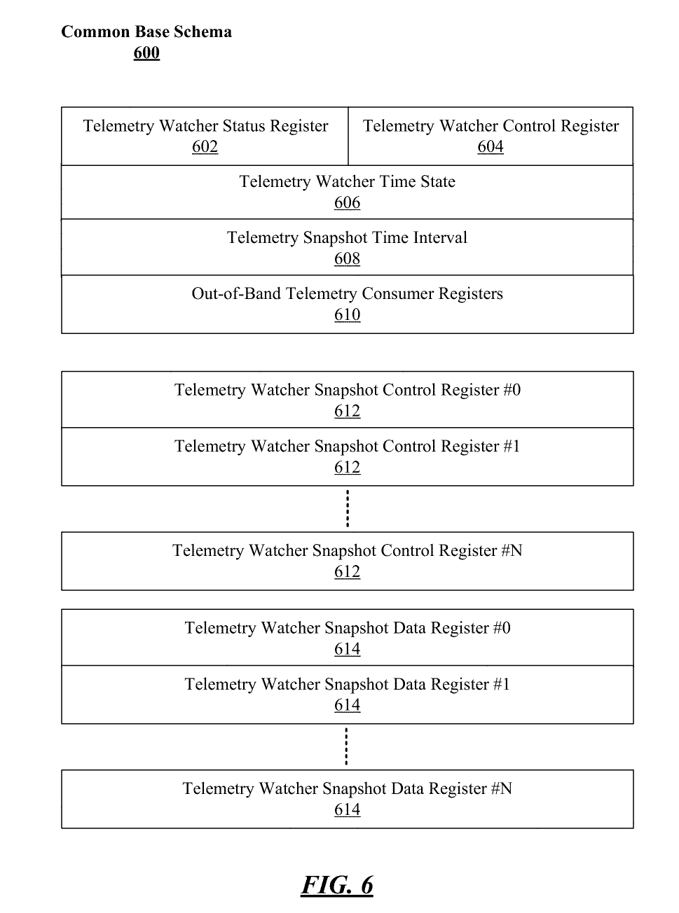

FIG. 6 illustrates an exemplary schema for common base 600 to implement a telemetry watcher on an integrated circuit in accordance with an embodiment of the present disclosure. In some examples, telemetry watchers 504 are derived from a common base. The common base 600 defines the basic set of configuration and status registers that are needed by a telemetry consumer (refer to FIGS. 3-4) to interface with the telemetry watcher 504. With some examples, the common base 600 may be extensible. For example, additional functionality may be provided through extensions to the common base 600 and/or through filtering mechanism that may be attached to telemetry watchers 504 implemented according to the common base 600.

As depicted, a telemetry watcher 504 implemented according to a common base schema 600 may include telemetry watcher status register 602, telemetry watcher control register 604, telemetry watcher time state 606, telemetry watcher snapshot interval register 608, telemetry consumers registers 610, telemetry watcher snapshot control registers 612, and telemetry watcher snapshot data registers 614.

In some examples, telemetry watcher status register 602 and telemetry watcher control register 604 can be sixty-four bits. In a specific example, the first thirty-two bits (or first double word) can be used to specify configuration of the telemetry watcher. For example, telemetry watcher control register 602 may be used to specify whether to enable the telemetry watcher, use telemetry watcher to push data to a telemetry consumer, reset the telemetry watcher, enable interrupting a telemetry watcher, or generate logs for a telemetry watcher activity. Similarly, the succeeding thirty-two bits (or second double word) can be used to specify status of the telemetry watcher. For example, telemetry watcher status register 604 may be used to specify whether the telemetry watcher is valid, frozen, busy, or interrupted.

Telemetry watcher time state 606 records the state of the telemetry watcher's internal clock. For example, whether the clock is frozen or running. Similarly, telemetry watcher snapshot interval register 608 may be arranged to store the length of time interval of recording telemetric data by the telemetry sensor associated with the telemetry watcher.

The telemetry watcher can include N (where N is a positive integer) telemetry consumers registers 610, for example, based on the number of telemetry consumers. Each telemetry consumer register 610 can store the destination address of a telemetry consumers. The telemetry watcher can further include N pairs of telemetry watcher snapshot control registers 612 and telemetry watcher snapshot data registers 614 for snapshots generated for each of the N telemetry consumers. With some examples, N is equal to 4 or greater.

As described above, some examples provide that the format and the configuration information as well as the events and the metrics available to a telemetry aggregator 302 associated with a TSS 304 are described in a definition schema (e.g., XML definition for TSS 304, or the like). It is to be appreciated, some deployments in which the present disclosure may be implemented (e.g., large scale software defined virtual topologies or software defined infrastructure (SDI)) may have thousands of telemetry sensors monitoring sever sub-circuits and generating telemetric data. In such examples, it may be inefficient and/or too computationally costly to go through aggregator discovery interface 406 and discovery registers 404 or to scan a large XML configuration file to discover the required TSS configuration.

As such, a TSS configuration version identification (ID) may be included within telemetry watcher control register 604 to facilitate faster discovery of the format, configuration information, events, and metrics associated with a telemetry aggregator 302. For example, in a cloud data center environment an SDI orchestration layers may quickly decipher the configuration of the telemetry infrastructure for any give sub-circuit (out of millions of sub-circuits under its control) by referencing a catalog of TSS configuration version IDs through telemetry watchers 504. Thus, the SDI orchestration layer may avoid traversing the sub-circuits to individually discover the telemetry configuration for their associated telemetry aggregators. An exemplary architecture for a part of telemetry watcher control register 604 showing the TSS configuration version ID is described in Table 2 shown below.

TABLE 2
TSS Version ID Schema

| Logical Offset | | |
|---|---|---|
| (Quad Word | Register | |
| or 64 bits) | Space | Description |
| 0 | TSS_version | Telemetry configuration version. |
| 1 | TSS_header | Telemetry header |
| 2 | Sernsor Data | Sensor for TelemID = 0 |
| 3 | Sensor Data | Sensor for TelemID = 1 |
| . . . | . . . | . . . |
| n-1 | Sensor Data | Sensor for TelemID = n |

During operation, the orchestration layer may write the TSS version ID to a hardware register in (e.g., response to a post telemetry configuration event, or the like) to lock the configuration in a known non-zero state. The hardware register (e.g., TSS configuration version ID register) is sufficient to define the full telemetry configuration and to allow for quick mapping of the node configuration to a known global configuration catalog. With some examples, TSS_version ID is the last write to the telemetry configuration space to a cataloged value. Therefore, any subsequent write to any writable telemetry configuration register will cause a zeroing of the TSS_version ID register to nullify the known configuration, and to indicate tampering from a known configuration.

### Aggregated Telemetry Watchers

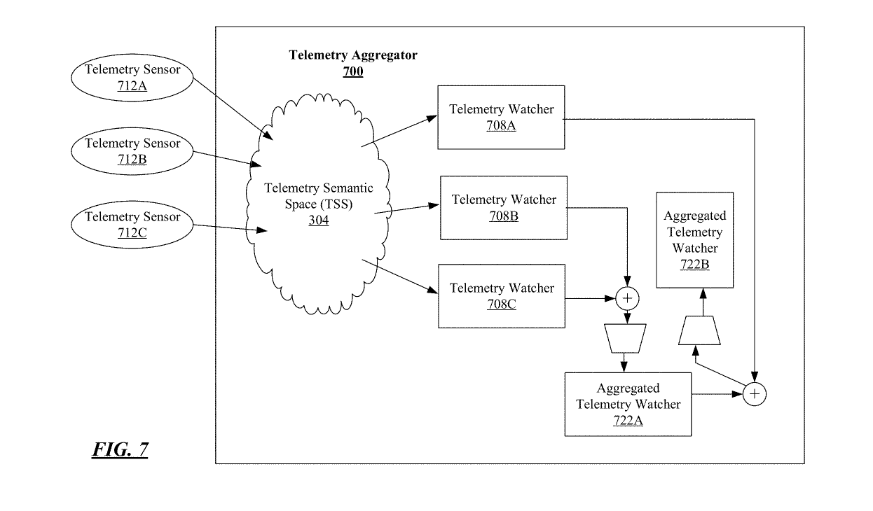

FIG. 7 depicts an example telemetry aggregator 700 including multiple aggregated telemetry watchers, implemented in accordance with embodiments of the present disclosure. The telemetry aggregator 700 can be representative of the telemetry aggregator 302 of telemetry architecture 300 FIG. 3. As such, for purposes of clarity, FIG. 7 and the telemetry aggregator 700 are discussed in relation to telemetry architecture 300 of FIG. 3. As depicted, telemetry aggregator 700 includes telemetry watcher 708A, telemetry watcher 708B, and telemetry watcher 708C. Telemetry aggregator 700 further includes TSS 304 coupled to telemetry sensors 712A, 712B and 712C. The components of telemetry aggregator 700 depicted in FIG. 7 may be similar to the components of telemetry aggregator 302 depicted in FIG. 3 or telemetry aggregator 400 depicted in FIG. 4.

Telemetry aggregator 700 further includes aggregated telemetry watcher 722A and aggregated telemetry watcher 722B. The aggregated telemetry watchers 722A and 722B can be implemented by logically combining (e.g., multiplexing, implementing a logical operation such as AND, OR, XOR, etc., or the like) the output of various other telemetry watchers. In general, the inputs to an aggregated telemetry watcher (e.g., the aggregated telemetry watchers 722A or 722B) may be from singular (or non-aggregated) telemetry watchers, aggregated telemetry watchers, or a combination of singular telemetry watchers and aggregated telemetry watchers. For example, as depicted, aggregated telemetry watcher 722A receives input based on the outputs of telemetry watchers 708B and 708C while aggregated telemetry watcher 722B receives input based on the outputs of telemetry watcher 708A and aggregated telemetry watcher 722A.

In some examples, aggregated telemetry watchers (e.g., aggregated telemetry watchers 722A and 722B, or the like) may extend the TSS beyond the capabilities provided by a singular instance of telemetry watchers, by for example, creating custom events and implementing special case algorithms by combining singular watchers (such as telemetry watcher 708B and telemetry watcher 708C) in logical configurations to extend their capabilities. With some examples, aggregated telemetry watchers can be implemented and arranged to provide services related to RAS (e.g., reliability, accessibility, and serviceability), power management, QoS, performance optimization, tuning, or user-specific algorithms.

Aggregated telemetry watchers (e.g., aggregated telemetry watchers 722A and 722B) may be useful in an SDI setting that require the orchestration layer of the SDI to pull the telemetric data each time a new event occurs (e.g., in cloud data centers with high frequency watcher events). It is to be appreciated, that such high frequency monitoring can consume significant bandwidth and resources. Aggregated telemetry watchers can provide capabilities for combining the high frequency events with other watcher events to fine tune the events and provide enhanced capabilities to the telemetry framework. Thereby increasing orchestration layer efficiency, particularly when considering the potentially millions of sub-circuits generating telemetry in a large-scale SDI framework.

Telemetry Aggregator with QoS for Telemetry Events

As noted, some embodiments of the present disclosure may provide QoS for telemetry events. With the increasing integration of accelerators, FPGAs, and other custom IP blocks with processors to form SoCs, there is a need to provide QoS for telemetry events. Some telemetry watchers or some telemetry events generated by telemetry watchers 504 may require QoS to ensure proper or timely management and handling. Examples of some cases which may benefit from QoS include custom IP and accelerators in datacenter products that have specified priority (e.g., in a service agreement, or the like), communication industry products that need QoS features for their payloads. For example, products like SNR for communications require telemetry QoS. SoCs incorporating CPUs and FPGAs may require event prioritization of their custom logic, instead of broader system telemetry events.

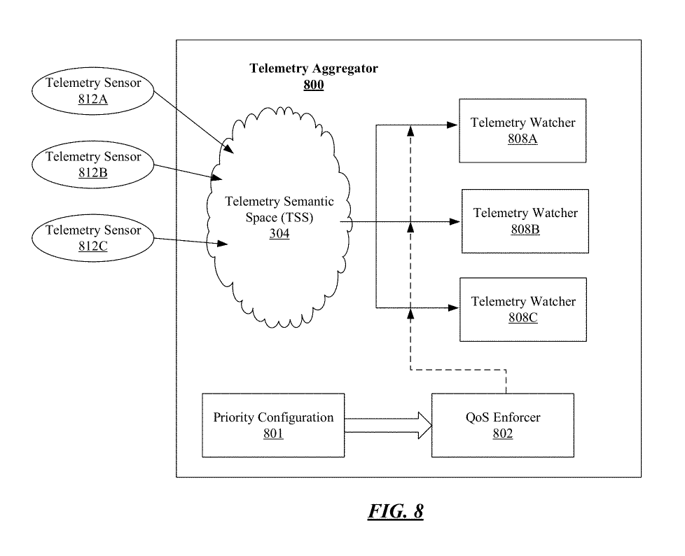

FIG. 8 depicts an example telemetry aggregator 800 arranged to provide QoS for telemetry events. The telemetry aggregator 800 can be representative of the telemetry aggregator 302 of telemetry architecture 300 FIG. 3. As such, for purposes of clarity, FIG. 8 and the telemetry aggregator 800 are discussed in relation to telemetry architecture 300 of FIG. 3. As depicted, telemetry aggregator 800 includes telemetry watcher 808A, telemetry watcher 808B, and telemetry watcher 808C. Telemetry aggregator 800 further includes TSS 304 coupled to telemetry sensors 812A, 812B and 812C. The components of telemetry aggregator 800 depicted in FIG. 8 may be similar to the components of telemetry aggregator 302 depicted in FIG. 3 or telemetry aggregator 400 depicted in FIG. 4.

Telemetry aggregator 800 further includes a priority configuration 801 and a QoS enforcer 802. During operation, telemetry events can be flagged based on a pre-determined QoS framework embodied in the priority configuration 801. Flagged telemetry events can be forwarded to QoS enforcer 802. QoS enforcer 802 can forward the events to each of telemetry watchers 808A to 808C, for example, via a prioritized communication channel.

With some examples, telemetry events may be captured as quickly as the underlying sub-circuit generates the events and reported by framework in an unbiased manner. Such operation may be referred to as “unfiltered” operation or “unfiltered QoS” and the QoS enforcer 8023 may be deactivated. With some embodiments, unfiltered QoS is the default operation for telemetry aggregators (e.g., telemetry aggregator 302, telemetry aggregator 400, telemetry aggregator 700, telemetry aggregator 800, or the like) and telemetry architecture 300.

An example of events for which unfiltered operation may be appropriate include voltage droop. With some examples, the QoS framework (e.g., priority configuration 801) is structured according to a priority order. For example, telemetry events from telemetry watchers (e.g., telemetry watchers 308A to 308C, telemetry watchers 504, or the like) are searched and reported in a pre-defined order. With some examples, this pre-defined order may be defined in telemetry watcher control register 604. The reporting may be done at the speed that the sub-circuit can find and report the event. For example, according to one pre-defined order, uncorrectable errors may be higher priority events than periodic reporting of voltage droop. Upon receiving an uncorrectable error (e.g., from a machine check architecture bank), QoS enforcer 802, based on priority configuration 801, can enforce the pre-defined order and send the uncorrectable error to telemetry watchers 808A to 808C on a priority basis.

With some examples, telemetry events from telemetry watchers 808A to 808C may be collected by hardware, but only reported once, based on a pre-defined configurable time window. For example, when an event is asserted, it may be reported at the end of the time interval. As such, a “heartbeat-type” reporting for certain events which do not require high bandwidth escalation may be provided. In some examples, the pre-defined configurable time window may run indefinitely, where events are always reported when the time lapses. For example, temperature of a sub-circuit may be monitored based on generating events after pre-determined intervals of time regardless of any changes in the temperature observer. With some examples, a pre-defined configurable time window may be triggered after the first event is detected and reported. Subsequent events can be reported when the pre-defined configurable time has lapsed. For example, an FPGA embedded with a CPU on an integrated circuit may report a first configuration error. At that point, a pre-defined time window may be triggered, and the FPGA can report its configuration status at the expiration of the pre-defined time window and expiration of every subsequent pre-defined time window.

### Telemetry Data Access Control

With some implementations, there may be a desire to control access to telemetry data. For example, there may be a need to control access to some registers of telemetry aggregator 302. It is to be appreciated, the implemented access controls may depend on the integrated circuit upon which telemetry architecture 300 is implemented. For example, in a server that distinguishes between access requests from out-of-band telemetry consumers and in-band telemetry consumers, the server's storage manager may implement different rules for different telemetry consumers.

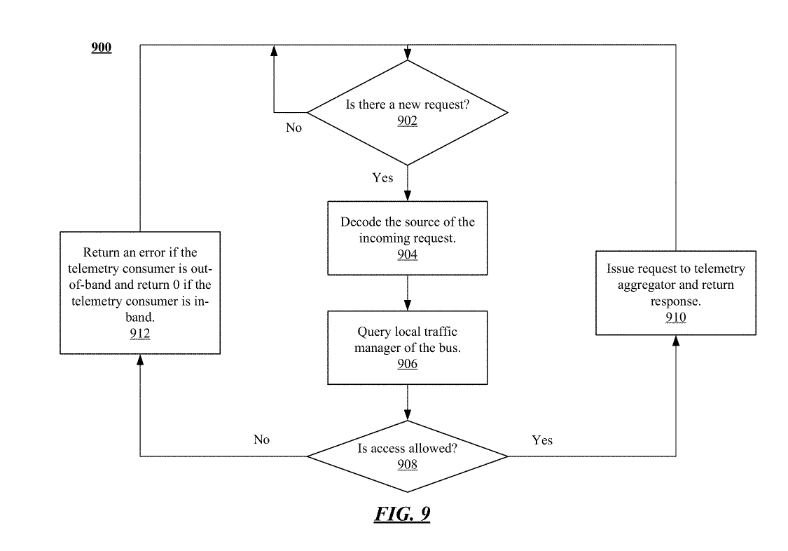

FIG. 9 depicts a logic flow 900, which may be representative of a process for implementing telemetry data access controls on an integrated circuit, according to embodiments of the present disclosure. Logic flow 900 may be representative of operations that may be performed by a telemetric architecture, such as telemetric architecture 300 of FIG. 3. For purposes of clarity, logic flow 900 is described with reference to telemetric architecture 300 of FIG. 3. However, examples of not limited in this context.

Logic flow 900 may begin at decision block 902. At decision block 902 “Is there a new request?” it may be determined if there is a new request for access to telemetry aggregator 302, and particularly to register (e.g., data registers 402, or the like) of telemetry aggregator 302. For example, the storage manager for an integrated circuit may determine if there are requests for access to registers of telemetry aggregator 302. If there are no requests the process may waits at decision block 902, otherwise the process may move to block 904. For example, logic flow 900 may continue from decision block 902 to block 904 based on a determination that a new request to access telemetric aggregator 302 is received.

At block 904 “Decode source of incoming request.” the source of the incoming request may be determined. For example, the storage manager for the integrated circuit on which the telemetry aggregator 3402 is implemented may decode the source of the incoming requests. The storage manager may identify whether the telemetry consumer requesting access is out-of-band or in-band.

Continuing to block 906 “Query local traffic manager of the bus.” the local traffic manager of the bus may be queried. For example, the storage manager can query the local traffic manager (LTM) of the communication bus that is used by telemetry consumer to request access to determine if the access request can be accommodated. Continuing to decision block 908 “Is access allowed?” it can be determined whether access is allowed, for example, based on the response of the query to the LTM (e.g., from block 906). The storage manager can determine whether access is allowed. If access is allowed (or granted) the logic flow can move to block 710, whereas if access is denied the logic flow can move to block 912.

At block 910 “Issue request to telemetry aggregator and return a response.” the storage manager issues a request to telemetry aggregator 302 to grant access by the telemetry consumer associated with the request. With some examples, the storage manager can return a response noting that access has been granted to the telemetry consumer requesting access.

At block 912 “Return an error if the telemetry consumer is out-of-band and return a 0 if the telemetry consumer is in-band.” the storage manager can return an error to the telemetry consumer requesting access, if the telemetry consumer is out-of-band. Additionally, the storage manager can return a null value (e.g., zero, or the like) if the telemetry consumer requesting access is in-band.

The logic flow 900 can return to decision block 902 from blocks 910 and 912 to process subsequently received access requests. In some examples, certain requests may be blocked or blacklisted and allowed or whitelisted by default. For example, read requests may be whitelisted whereas write requests may be blacklisted by default. Additionally, certain registers of telemetry aggregator 302 may be blacklisted by default.

### Telemetry Snapshot

The existing mechanisms for taking a snapshot of telemetry architecture 300 typically rely on stopping all collection of telemetric data, freezing all telemetry of resources, taking the snapshot, and restarting the collection of telemetric data. However, this situation can be undesirable. For example, for telemetry collection in SDI environments in case of critical (like voltage droop), time sensitive or protected telemetric data (like that from protected IP blocks, or in industrial IoT implementations), the orchestration layer delay in traversing thousands of telemetry aggregators and their XML definitions would take a long time. Many environments require continuous collection of telemetric data while capturing a snapshot.

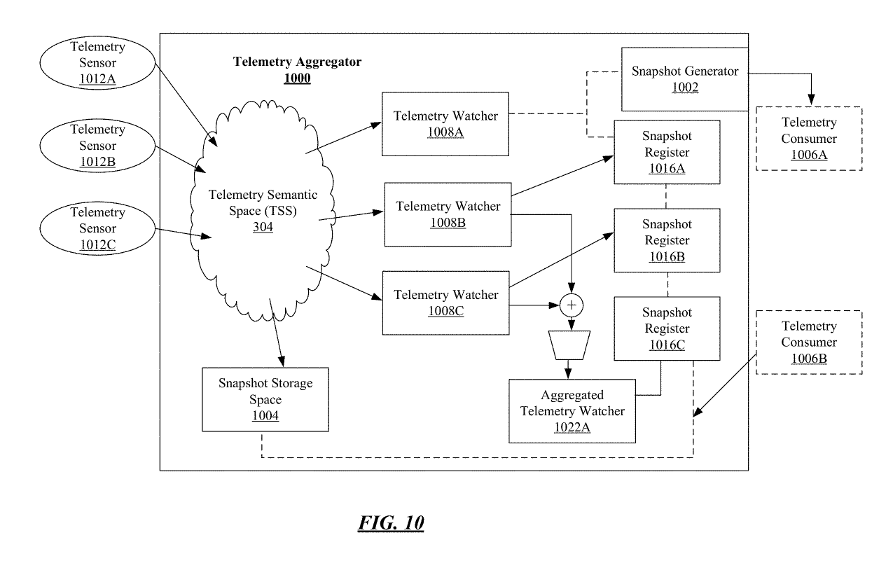

FIG. 10 depicts an example telemetry aggregator 1000 arranged to snapshot telemetric data. The telemetry aggregator 1000 can be representative of the telemetry aggregator 302 of telemetry architecture 300 FIG. 3. As such, for purposes of clarity, FIG. 10 and the telemetry aggregator 1000 are discussed in relation to telemetry architecture 300 of FIG. 3. As depicted, telemetry aggregator 1000 includes telemetry watcher 1008A, telemetry watcher 1008B, and telemetry watcher 1008C. Telemetry aggregator 1000 further includes TSS 304 coupled to telemetry sensors 1012A, 1012B and 1012C. The components of telemetry aggregator 1000 depicted in FIG. 10 may be similar to the components of telemetry aggregator 302 depicted in FIG. 3 or telemetry aggregator 400 depicted in FIG. 4.

Telemetry aggregator 1000 further includes a snapshot generator 1002 to generate a snapshot of the entire telemetry architecture (e.g., telemetry architecture 300) across a socket, a system, a rack, or a datacenter. Snapshot generator 1002 can be arranged to generate a snapshot of the telemetry architecture at any given time while at the same time not loose telemetric data and events.

With some examples, if the snapshot mechanism is implemented on a SDI then while the telemetric data is being continuously collected, the orchestration layer services the snapshot data. In some examples, snapshot generator 1002 sends the generated snapshots to a requesting telemetry consumer (e.g., telemetry consumer 1006A, or the like). Similarly, snapshot generator 1002 may receive signals from telemetry watcher 1008A to generate a snapshot of the telemetry architecture (e.g., telemetry architecture 300, or the like). Snapshot generator 1002 may be configured to enable globally coordinated events (e.g., countdowns from a global clock or periodic intervals, or the occurrence of telemetry watcher events). Snapshot generator 1002 can coordinate snapshot events across a subset of telemetry aggregators or integrated circuits (whether in the same device or connected across networks).

Telemetry aggregator 1000 further includes snapshot storage space 1004 to store snapshot data generated by snapshot generator 1002. In some examples, snapshot storage space 1004 may be implemented as a part of TSS 304. Similarly, snapshot storage space 1004 may be distinct from TSS 304. Snapshot storage space can receive signal to store snapshot data from a telemetry consumer (e.g., telemetry consumer 1006B, or the like).

Telemetry aggregator 1000 further includes snapshot register 1006A, snapshot register 1006B, and snapshot register 1006C, which are coupled to telemetry watchers 1006A to 1006C. A snapshot register 1006A to 1006C may be similar to telemetry watcher control register 604. Snapshot registers 1006A to 1006C capture counter and/or events from telemetry watchers and store the snapshot data in snapshot storage space 1004. In case of SDI environments, the snapshot data may also be sent to the orchestration layer, while the telemetry watchers continue to collect telemetry.

### Telemetry Configuration Hashing

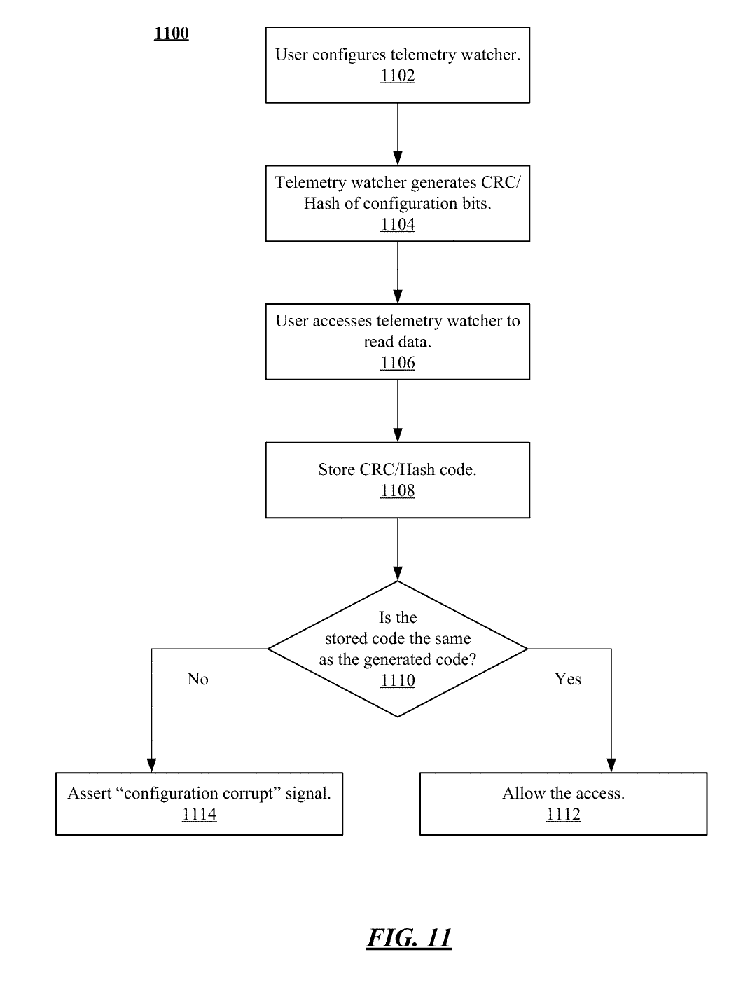

FIG. 11 depicts a logic flow 1100, which may be representative of a process for hashing telemetric configurations to reduce tampering, according to embodiments of the present disclosure. Logic flow 1100 may be implemented to create a hash or cyclic redundancy check (CRC) code of the XML definitions that forms the hardware configuration information of telemetry watchers 504 to prevent tampering. The hash can be used to detect malicious intrusions or errors (soft errors or errors induced by other mechanisms such as aging) that may alter the telemetry configuration leading to incorrect or invalid data being fed into control algorithms or decisions.

Logic flow 1100 may be representative of operations that may be performed by a telemetric architecture, such as telemetric architecture 300 of FIG. 3. For purposes of clarity, logic flow 1100 is described with reference to telemetric architecture 300 of FIG. 3 and particularly to telemetric aggregator 500 of FIG. 5 and the telemetric watchers 504. However, examples of not limited in this context.

Logic flow 1100 may begin at decision block 1102. At decision block 1102 “User configures telemetry watcher” a user may configure a telemetry watcher 504, for example, by storing configuration in telemetry watcher control register 604 of the telemetry watcher. Logic flow 110 may additionally include an operation to reset a signal indicating a corrupt configuration file. With some examples, the signal is reset in parallel with operation of block 1102.

Continuing to block 1104 “Telemetry watcher generates CRC/Hash of configuration” the telemetry watcher 504 generates a CRC or hashed code from the configuration information. For example, telemetry watcher 504 may generate a hash using SHA or any other hashing algorithm.

At block 1106 “a user accesses the telemetry watcher” a user can access the configured telemetry watcher 504. For example, a user can access the telemetry watcher 504 to read data. Continuing to block 1108 “store CRC/Hash code” a telemetry watcher can store a hash or CRC of the configuration file, for example, in response to a user accessing the XML file for the telemetry watcher.

Continuing to decision block 1110 “Is the stored code the same as the generated code?” the stored code can be compared to the generated code to determine whether they match. If the codes match, then logic flow 1100 can move block 1112 “Allow the access” where the user is given access to read telemetry data. However, if the codes don't match, then logic flow 1100 can move to block 1114 “Assert ‘configuration corrupt’ signal” where the configuration corrupt signal can be asserted or set to indicate an error or tampering with the configuration information.

### Telemetry Reservation

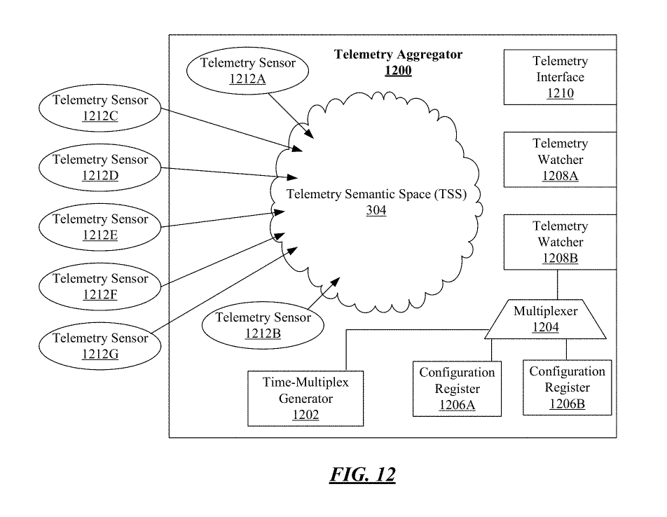

FIG. 12 depicts an example telemetry aggregator 1200 arranged to provide telemetry reservation. The telemetry aggregator 1200 can be representative of the telemetry aggregator 302 of telemetry architecture 300 FIG. 3. As such, for purposes of clarity, FIG. 12 and the telemetry aggregator 1200 are discussed in relation to telemetry architecture 300 of FIG. 3. As depicted, telemetry aggregator 1200 includes telemetry watcher 1208A and telemetry watcher 1208B. Telemetry aggregator 1200 further includes TSS 304 coupled to telemetry sensors 1212A, 1212B, 1212C, 1212D, 1212E, 1212F and 1212G. The components of telemetry aggregator 1200 depicted in FIG. 10 may be similar to the components of telemetry aggregator 302 depicted in FIG. 3, telemetry aggregator 400 depicted in FIG. 4, or telemetry aggregator 500 depicted in FIG. 5.

Telemetry aggregator 1200 further includes time-multiplex generator 1202 and multiplexer 1204. Time-multiplex generator 1202 is coupled to multiplexer 1204. Multiplexer 1204 is coupled to configuration register 1206A and configuration register 1206B. The multiplexer 1204 can further be coupled to telemetry watcher 1208B.

The telemetry architecture 300 in which telemetry aggregator 1200 is implemented can provide for the time-multiplexing of multiple telemetry watcher configurations, for example, to collect events in a round robin fashion. Time-multiplexed telemetry watchers can switch contexts on a time multiple fashion to capture information of lower priority or infrequent events. In some examples, configuration registers 1206A to 1206B may be multiplexed by the telemetry watchers and switched on the basis of an event generator signal received from time-multiplex generator 1202.

### Telemetry for Virtual Machines

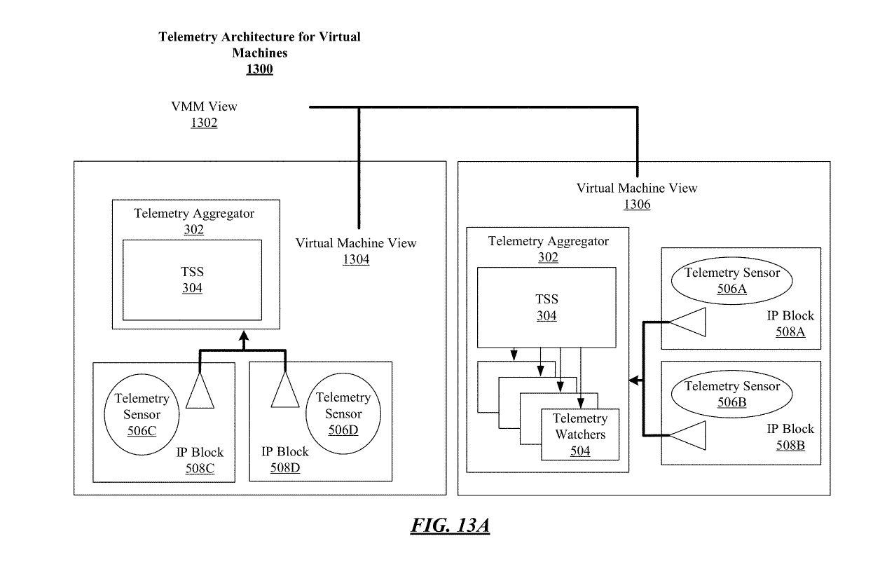

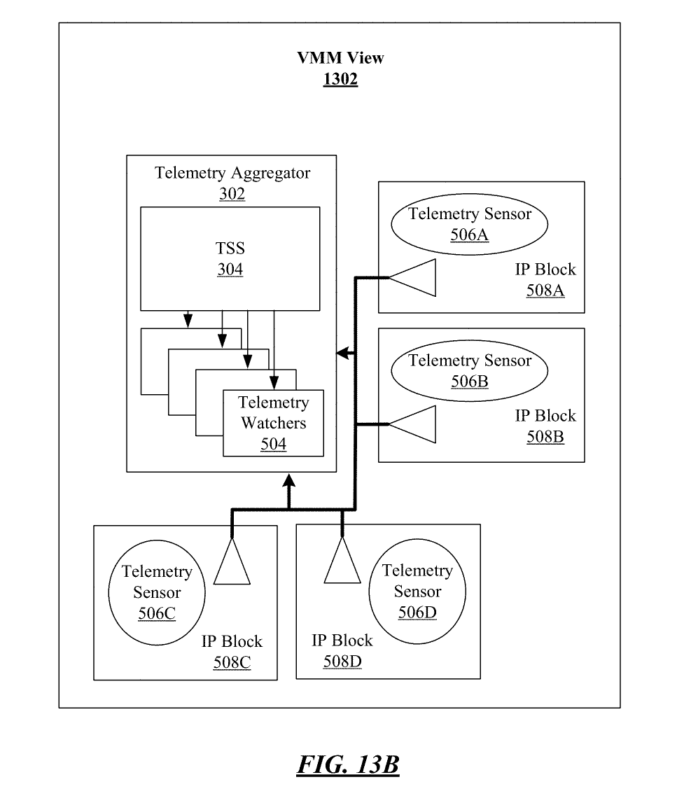

FIG. 13A-FIG. 13B illustrate an exemplary telemetry architecture 1300 implemented across virtual machines. It is to be appreciated that virtual machines may be deployed across computing hardware comprising integrated circuits, such as, for example, in a cloud environment. The telemetry architecture 1300 can be representative of the telemetry architecture 300 of FIG. 3. As such, for purposes of clarity, FIG. 13A-FIG. 13B and the telemetry architecture 1300 are discussed in relation to telemetry architecture 300 of FIG. 3. Telemetry architecture 1300 includes a virtual machine monitor (VMM) view view 1302 as well as multiple virtual machine views. For example, virtual machine view 1304 and virtual machine view 1306 are depicted.

As depicted, each view (e.g., VMM view 1302, virtual machine view 1304, virtual machine view 1306, or the like) includes a telemetry architecture, and specifically a telemetry aggregator. The telemetry aggregators may be like any of the other telemetry aggregators discussed herein, such as, for example, telemetry aggregator 302 depicted in FIG. 3, telemetry aggregator 400 depicted in FIG. 4, telemetry aggregator 500 depicted in FIG. 5, telemetry aggregator 700 depicted in FIG. 7, telemetry aggregator 800 depicted in FIG. 8, telemetry aggregator 1000 depicted in FIG. 10, or telemetry aggregator 1200 depicted in FIG. 12.

With some examples, VMM view 1302 is available to the virtual machine monitor (VMM), orchestrator, hypervisor, etc. upon which the virtual machine telemetry is implemented. The VMM can be a native or bare-metal manager, which operates directly on the integrated circuit. The VMM may be a hosted VMM that is implemented on a conventional operating system. The VMM can be implemented in a cloud data center type environment. In general, the VMM view 1302 allows the VMM to access all the resources of telemetry architecture 300, including telemetry aggregator 302, TSS 304, telemetry watchers 504, telemetry sensors 506A-D, and IP blocks 508A-D. The VMM may include the ability to collect telemetry per virtual machine, for example, by assigning a remote machine identification (RMID) to each virtual machine operating on the platform and using the RMID to determine which virtual machine owns or has access to which telemetry resources. The RMID may also be used by the time-multiplex event generator 1202 described above to select when and which configuration the watchers will use.

In general, a virtual machine view (e.g., virtual machine view 1304, virtual machine view 1306, or the like) illustrates that virtual machine with a “view” only to the resources of the entirety upon which the virtual machine is implemented. For example, the virtual machine with virtual machine view 1306 may access IP blocks 508C to 508D and telemetry sensors 506C to 506D, which limits that virtual machines ability to collect telemetric data related to other IP blocks, telemetry sensors, and events. Similarly, the virtual machine with virtual machine view 1304 has access to limited resources of the entirety of resources available to the hypervisor. For example, the virtual machine with virtual machine view 1304 can access telemetry watchers 504, IP blocks 508A to 508B and telemetry sensors 506A to 506B, which limits that virtual machines ability to collect telemetric data related to other IP blocks, telemetry sensors, and events.

The following provide further example embodiments:

### EXAMPLE 1

A system comprising: a memory circuit to store a set of telemetric data, the set of telemetric data generated by a plurality of telemetry sensors; an aggregation module coupled to the memory circuit; and a consumer circuit to query the aggregation module for a subset of the set of telemetric data stored in the memory circuit.

### EXAMPLE 2

The system of example 1, the memory circuit comprising a memory mapped input-output flat memory space.

### EXAMPLE 3

The system of example 1, the aggregation module comprising: one or more data registers accessible by the consumer circuit, the one or more data registers to store an indication of the subset of telemetric data requested by the consumer circuit; one or more discovery registers, the one or more discovery registers to store indications of the set of telemetric data stored in the memory circuit; and a discovery interface coupled to the one or more discovery registers and the consumer circuit, the discover interface to provide access to the discovery registers by the consumer circuit.

### EXAMPLE 4

The system of example 3, comprising a discovery list accessible by the consumer circuit, the discovery list to store indications of links to discovery interfaces of a plurality of aggregation modules, the plurality of aggregation modules to include the aggregation module.

EXAMPLE 5

The system of example 3, comprising a memory block accessible to both the aggregation module and the consumer circuit, the data registers implemented in the memory block.

### EXAMPLE 6

The system of example 3, the consumer circuit to comprise the one or more data registers.

### EXAMPLE 7

The system of example 1, comprising an observation module, the observation module arranged to process a query, from the consumer circuit, of the set of telemetric data via the aggregation module, the query to include an indication for a sub-set of the set of telemetric data based on a set of metrics and events.

### EXAMPLE 8

The system of example 7, the observation module to determine a frequency of generating the sub-set of the set of telemetric data based on output from the telemetry sensors.

### EXAMPLE 9

The system of example 8, the observation module comprising an interrupt configuration register, a global time stamp, and an interrupt observation module register.

### EXAMPLE 10

The system of example 1, the plurality telemetry sensors to comprise at least one of a temperature sensing system, a fully integrated voltage regulator (FIVR) rail, a free running counter, a counter, a voltage droop measuring (VDM) system, a central processing unit (CPU) current load monitor, an energy counter, a reliability odometer, a machine check architecture (MCA) bank, or a time-in-state residency.

### EXAMPLE 11

The system of example 1, the plurality of telemetry sensors coupled to one or more of a plurality of integrated circuits of a computing system.

### EXAMPLE 12

The system of example 11, the plurality of integrated circuits comprising at least one of a processor, an intellectual property block, a hard disk drive, a memory channel, an input-output link, an interconnect fabric, or a double data rate memory circuit.

### EXAMPLE 13

The system of example 11, the computing system is one of: a personal computer, a smartphone, a car, or a server in a cloud data center.

### EXAMPLE 14

The system of example 1, the consumer circuit comprising an in-band consumer circuit.

### EXAMPLE 15

The system of example 1, the consumer circuit comprising an out-of-band consumer circuit.

### EXAMPLE 16

The system of example 1, a comprising: a communication bus coupling the aggregation module and the consumer circuit; and a set of commands mapped onto the communication bus, the set of commands to provide access to the aggregation module by the consumer circuit via the communication bus.

### EXAMPLE 17

The system of example 16, the communication bus comprising a management component transport protocol (MCTP) bus.

### EXAMPLE 18

A computer-implemented method, comprising: receiving a plurality of indications of telemetric data from a plurality of telemetry sensors; storing, to a non-transitory memory, the plurality of indications of telemetric data, the stored plurality of indications of telemetric data forming a set of telemetric data; receiving, at an aggregation module coupled to the non-transitory memory, a query for a subset of the set of telemetric data, the query received from a consumer circuit; and processing, by the aggregation module.

### EXAMPLE 19

The computer-implemented method of example 18, storing the plurality of indication of the telemetric data comprising storing the plurality of indication of telemetric data to a memory mapped input-output flat memory space.

### EXAMPLE 20

The computer-implemented method of example 18, comprising determining parameters of the query based on indications of the subset of the set of telemetric data from one or more data registers.

### EXAMPLE 21

The computer-implemented method of example 20, the one or more data registers implemented in a memory block accessible to both the aggregation module and the consumer circuit.

### EXAMPLE 22

The computer-implemented method of example 20, the consumer circuit to comprise the one or more data registers.

### EXAMPLE 23

The computer-implemented method of example 18, comprising determining a frequency of generating the subset of the set of telemetric data based on output from the telemetry sensors.

### EXAMPLE 24

The computer-implemented method of example 18, the plurality telemetry sensors to comprise at least one of a temperature sensing system, a fully integrated voltage regulator (FIVR) rail, a free running counter, a counter, a voltage droop measuring (VDM) system, a central processing unit (CPU) current load monitor, an energy counter, a reliability odometer, a machine check architecture (MCA) bank, or a time-in-state residency.

### EXAMPLE 25

The computer-implemented method of example 18, the plurality of telemetry sensors coupled to one or more of a plurality of integrated circuits of a computing system.

### EXAMPLE 26

The computer-implemented method of example 25, the plurality of integrated circuits comprising at least one of a processor, an intellectual property block, a hard disk drive, a memory channel, an input-output link, an interconnect fabric, or a double data rate memory circuit.

### EXAMPLE 27

The computer-implemented method of example 25, the computing system one of: a personal computer, a smartphone, a car, or a server in a cloud data center.

### EXAMPLE 28

The computer-implemented method of example 18, comprising receiving the query from the consumer circuit via in-band signaling.

### EXAMPLE 29

The computer-implemented method of example 18, comprising receiving the query from the consumer circuit via out-of-band signaling.

### EXAMPLE 30

The computer-implemented method of example 18, comprising receiving the query from the consumer circuit via a communication bus coupling the aggregation module and the consumer circuit, the communication bus associated with a set of commands mapped onto the communication bus, the set of commands to provide access to the aggregation module by the consumer circuit via the communication bus.

### EXAMPLE 31

The computer-implemented method of example 30, the communication bus comprising a management component transport protocol (MCTP) bus.

### EXAMPLE 32

An apparatus comprising means to perform the method of any one of examples 18 to 30.

### EXAMPLE 33

At least one machine-readable storage medium comprising instructions that when executed by a processor, cause the processor to perform the method of any one of examples 18 to 30.

It is emphasized that the Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A system comprising:
a memory circuit to store a set of telemetric data, the set of telemetric data generated by a plurality of telemetry sensors;
an aggregation module coupled to the memory circuit; and
a consumer circuit to query the aggregation module for a subset of the set of telemetric data stored in the memory circuit.

2. The system of claim 1, the memory circuit comprising a memory mapped input-output flat memory space.

3. The system of claim 1, the aggregation module comprising:
one or more data registers accessible by the consumer circuit, the one or more data registers to store an indication of the subset of telemetric data requested by the consumer circuit;
one or more discovery registers, the one or more discovery registers to store indications of telemetric data stored in the memory circuit; and
a discovery interface coupled to the one or more discovery registers and the consumer circuit, the discover interface to provide access to the discovery registers by the consumer circuit.

4. The system of claim 3, comprising a discovery list accessible by the consumer circuit, the discovery list to store indications of links to discovery interfaces of a plurality of aggregation modules, the plurality of aggregation modules to include the aggregation module.

5. The system of claim 3, comprising a memory block accessible to both the aggregation module and the consumer circuit, the data registers implemented in the memory block.

6. The system of claim 3, the consumer circuit to comprise the one or more data registers.

7. The system of claim 1, comprising an observation module, the observation module arranged to process a query, from the consumer circuit, of the set of telemetric data via the aggregation module, the query to include an indication for a sub-set of the set of telemetric data based on a set of metrics and events.

8. The system of claim 7, the observation module to determine a frequency of generating the sub-set of the set of telemetric data based on output from the telemetry sensors.

9. The system of claim 8, the observation module comprising an interrupt configuration register, a global time stamp, and an interrupt observation module register.

10. The system of claim 1, the plurality telemetry sensors to comprise at least one of a temperature sensing system, a fully integrated voltage regulator (FIVR) rail, a free running counter, a counter, a voltage droop measuring (VDM) system, a central processing unit (CPU) current load monitor, an energy counter, a reliability odometer, a machine check architecture (MCA) bank, or a time-in-state residency.

11. The system of claim 1, the plurality of telemetry sensors coupled to one or more of a plurality of integrated circuits of a computing system.

12. The system of claim 11, the plurality of integrated circuits comprising at least one of a processor, an intellectual property block, a hard disk drive, a memory channel, an input-output link, an interconnect fabric, or a double data rate memory circuit.

13. The system of claim 11, the computing system is one of: a personal computer, a smartphone, a car, or a server in a cloud data center.

14. The system of claim 1, the consumer circuit comprising an in-band consumer circuit.

15. The system of claim 1, the consumer circuit comprising an out-of-band consumer circuit.

16. The system of claim 1, a comprising:
a communication bus coupling the aggregation module and the consumer circuit; and
a set of commands mapped onto the communication bus, the set of commands to provide access to the aggregation module by the consumer circuit via the communication bus.

17. The system of claim 16, the communication bus comprising a management component transport protocol (MCTP) bus.

18. A computer-implemented method, comprising:
receiving a plurality of indications of telemetric data from a plurality of telemetry sensors;
storing, to a non-transitory memory, the plurality of indications of telemetric data, the stored plurality of indications of telemetric data forming a set of telemetric data;
receiving, at an aggregation module coupled to the non-transitory memory, a query for a subset of the set of telemetric data, the query received from a consumer circuit; and
processing, by the aggregation module, the query.

19. The computer-implemented method of claim 18, storing the plurality of indication of the telemetric data comprising storing the plurality of indication of telemetric data to a memory mapped input-output flat memory space.

20. The computer-implemented method of claim 18, comprising determining parameters of the query based on indications of the subset of the set of telemetric data from one or more data registers.

21. The computer-implemented method of claim 18, comprising receiving the query from the consumer circuit via in-band signaling or via out-of-band signaling.

22. The computer-implemented method of claim 1, comprising receiving the query from the consumer circuit via a communication bus coupling the aggregation module and the consumer circuit, the communication bus associated with a set of commands mapped onto the communication bus, the set of commands to provide access to the aggregation module by the consumer circuit via the communication bus.

23. At least one machine-readable storage medium comprising instructions that when executed by a processor, cause the processor to:
receive a plurality of indications of telemetric data from a plurality of telemetry sensors;
store, to a non-transitory memory coupled to the processor, the plurality of indications of telemetric data, the stored plurality of indications of telemetric data forming a set of telemetric data;
receive, from a consumer circuit coupled to the processor, a query for a subset of the set of telemetric data; and
process the query.

24. The at least one machine-readable storage medium of claim 23, the instructions that when executed by a processor, cause the processor to store the plurality of indication of the telemetric data comprising storing the plurality of indication of telemetric data to a memory mapped input-output flat memory space.

25. The at least one machine-readable storage medium of claim 24, the instructions that when executed by a processor, cause the processor to receive the query from the consumer circuit via a communication bus coupling the processor and the consumer circuit module, the communication bus associated with a set of commands mapped onto the communication bus, the set of commands to provide access to the aggregation module by the consumer circuit via the communication bus.
